(19) United States
(12) Patent Application Publication
(10) Pub. No.: US 2017/0132920 A1
(43) Pub. Date: May 11, 2017

(54) Vehicle Speed Monitoring Method and Device

(71) Applicant: Leauto Intelligent Technology (BEIJING) Co. Ltd, Beijing (CN)

(72) Inventors: Yong Xu, Beijing (CN); Yu Zou, Beijing (CN); Kunsheng Chen, Beijing (CN); Wenrui Li, Beijing (CN); Dan Li, Beijing (CN); Peng Liu, Beijing (CN); Wei Lin, Beijing (CN)

(73) Assignee: Leauto Intelligent Technology (BEIJING) Co. Ltd, Beijing (CN)

(21) Appl. No.: 14/966,647

(22) Filed: Dec. 11, 2015

(30) Foreign Application Priority Data
Nov. 5, 2015 (CN) 201510746695.2

(51) Int. Cl. G08G 1/052; G01P 7/00; G07C 5/00

(52) U.S. Cl. CPC G08G 1/052; G07C 5/008; G01P 7/00

(57) ABSTRACT

Embodiments of the disclosure provide a vehicle speed monitoring method and device. The method comprises: acquiring limited speed information of a current road; calculating the instantaneous speed of a current vehicle; and judging whether the instantaneous speed of the current vehicle is greater than the limited speed of the current road, and if so, outputting speeding information; wherein the current vehicle has diameter information of wheels, and the step of calculating the instantaneous speed of the current vehicle comprises: acquiring the time used for the wheels to run one cycle; and calculating the instantaneous speed of the current vehicle according to the diameter information of the wheels and the time used for the wheels to run one cycle.

### FIELD OF TECHNOLOGY

The present disclosure relates to the technical field of vehicles, and particularly relates to a vehicle speed monitoring method and device.

### BACKGROUND

In order to ensure road traffic safety, the traffic management department respectively sets corresponding limited speeds for different roads, and various vehicles must run according to the specified speeds to prevent accidents. According to statistics, speeding is the primary reason for traffic accidents, and seriously threatens the safety of people's life and properties. Thus, vehicle speed monitoring has become an important content of traffic enforcement.

At present, the traffic management department mainly monitors the vehicle speeds in the following manners: I, the vehicle speeds are monitored by utilizing speed measurers, e.g. speed measurement cameras are installed on roads, or mobile speed measurement stations are utilized, but this method cannot cover the whole roads and cannot monitor the vehicle speeds at the road sections which cannot be monitored by the speed measurement cameras or the mobile speed measurement stations, moreover, the speed measurement cameras or the mobile speed measurement stations can be early warned through navigation software and the like; II, the speeds are measured on the basis of the access areas of toll lanes, password cards are taken at the entrances of the toll lanes to record the entrance time and read at the exits to record the exit time, the vehicle speeds are monitored by calculating the average speeds of the intervals, but the average speeds can neither reflect the real-time speeds of vehicles, nor reflect the time used for the vehicles to stay at service stations, meanwhile, this method cannot monitor vehicle speeding on common roads; moreover, the vehicle speeds may also be monitored through GPS, but GPS signals are attenuated greatly in severe weathers such as rain and snow and cannot be used for accurately measuring the speeds, and the GPS signals fail inside tunnels. Therefore, the vehicle speeds can hardly be accurately monitored in real time according to the existing technical solutions.

### SUMMARY

The present disclosure provides a vehicle speed monitoring method and device to overcome the shortcoming that vehicle speed monitoring in the prior art cannot accurately reflect the running speed of a vehicle and realizing automatic monitoring of the instantaneous speed of a current vehicle.

The present disclosure provides a vehicle speed monitoring method, including:

acquiring limited speed information of a current road;

calculating the instantaneous speed of a current vehicle; and

judging whether the instantaneous speed of the current vehicle is greater than the limited speed of the current road, and if so, outputting speeding information;

wherein the current vehicle has diameter information of wheels, and the step of calculating the instantaneous speed of the current vehicle includes:

acquiring the time used for the wheels to run one cycle; and

calculating the instantaneous speed of the current vehicle according to the diameter information of the wheels and the time used for the wheels to run one cycle.

The present disclosure also provides a vehicle speed monitoring device, including:

a limited speed information acquisition module for acquiring limited speed information of a current road;

an instantaneous speed calculation module for calculating the instantaneous speed of a current vehicle; and

an speeding judgment and output module for judging whether the instantaneous speed of the current vehicle is greater than the limited speed of the current road, and if so, outputting speeding information;

wherein the current vehicle has diameter information of wheels, and the instantaneous speed calculation module includes:

a wheel running time acquisition sub-module for acquiring the time used for the wheels to run one cycle; and

an instantaneous speed calculation sub-module for calculating the instantaneous speed of the current vehicle according to the diameter information of the wheels and the time used for the wheels to run one cycle.

According to the vehicle speed monitoring method and device provided by the present disclosure, the time used for the wheels to run one cycle is acquired, then the instantaneous speed of the current vehicle is calculated, whether the instantaneous speed is greater than the limited speed of the current road is judged, and if so, the speeding information is output, so that the shortcoming that the vehicle speed monitoring in the prior art cannot accurately reflect the running speed of the vehicle is overcome, automatic monitoring of the instantaneous speed of the current vehicle is realized, and the accuracy of monitoring data is improved.

### BRIEF DESCRIPTION OF THE DRAWINGS

In order to describe the technical solutions in the embodiments of the present disclosure or in the prior art more clearly, a simple introduction to the accompanying drawings which are needed in the description of the embodiments or the prior art is given below. Apparently, the accompanying drawings in the description below are merely some of the embodiments of the present disclosure, based on which other drawings may be obtained by those of ordinary skill in the art without any creative effort.

FIG. 1 is a flow diagram of embodiment 1 of a vehicle speed monitoring method of the present disclosure;

FIG. 2 is a flow diagram of embodiment 2 of the vehicle speed monitoring method of the present disclosure;

FIG. 3 is a structural schematic diagram of an embodiment of a vehicle speed monitoring device of the present disclosure.

### DESCRIPTION OF THE EMBODIMENTS

To make the objectives, technical solutions and advantages of the embodiments of the present disclosure clearer, a clear and complete description of the technical solutions in the present disclosure will be given below, in combination with the accompanying drawings in the embodiments of the present disclosure. Apparently, the embodiments described below are part, but not all, of the embodiments of the present disclosure. All of other embodiments obtained by those of ordinary skill in the art based on the embodiments of the present disclosure without any inventive efforts fall into the protection scope of the present disclosure.

Refer to FIG. 1, which shows a flow diagram of embodiment 1 of a vehicle speed monitoring method of the present disclosure. The method specifically may include the following steps.

Step 101, limited speed information of a current road is acquired.

Different roads have different speed limiting requirements, e.g. according to the provisions of relevant laws and regulations in China, the maximum speed is not more than 120 kilometers per hour and the minimum speed is not less than 60 kilometers per hour on the expressway, and even the speed limiting requirements for different lanes of the same road are also different. Thus, in the embodiment of the present disclosure, the limited speed information of the current road may be acquired in advance.

In specific implementation, when a vehicle enters an expressway, the limited speed information of the current lane may be set in advance, and when the vehicle changes the lane, the limited speed information after lane change may be acquired through Internet of Vehicles V2X; and with respect to a common road, the position of the vehicle may be determined in a GPS positioning manner, and then the limited speed information of the road section is acquired.

Step 102, the instantaneous speed of a current vehicle is calculated.

The instantaneous speed reflects the speed of the vehicle at a certain moment or a certain road section. When the vehicle runs, the instantaneous speed can reflect the running state of the current vehicle relative the average speed, and thus, in the embodiment of the present disclosure, the instantaneous speed of the current vehicle can be acquired by calculating.

In specific implementation, the wheel diameter data of the current vehicle can be acquired in advance, and the instantaneous speed of the current vehicle is calculated according to the running distance and time of wheels.

In the embodiment of the present disclosure, calculating of the instantaneous speed of the current vehicle specifically may include the following sub-steps:

step S21, acquiring the time used for the wheels to run one cycle; and

step S22, calculating the instantaneous speed of the current vehicle according to the diameter information of the wheels and the time used for the wheels to run one cycle.

In specific implementation, in order to calculate the instantaneous speed of the current vehicle, the time used for the wheels to run one cycle can be recorded in real time, meanwhile, the distance when the wheels run one cycle can be obtained according to the diameter data of the wheels, and then the instantaneous speed of the current vehicle is calculated.

As is well know, the instrument panel of the vehicle also displays the speed of the current vehicle, but the speed displayed on the instrument panel is average speed of the current vehicle in a period of past time, e.g. the average speed of the current speed in the past one second. Although this period of time is relatively short, it cannot represent the instantaneous speed of the current vehicle, moreover, in practice, the speed displayed by the instrument panel should be higher than the real speed of the vehicle according to relevant requirements, which further influences the speed displayed by the instrument panel. In the embodiment of the present disclosure, the speed of the current vehicle, which is calculated by acquiring the time used for the wheels to run one cycle, can be approximately equivalent to the instantaneous speed of the current vehicle.

In implementation of the present disclosure, after the instantaneous speed of the current vehicle is acquired, step 103 may be further executed, to compare the instantaneous speed of the current vehicle with the limited speed of the current road.

Step 103, whether the instantaneous speed of the current vehicle is greater than the limited speed of the current road is judged, and if so, speeding information is output.

After the instantaneous speed of the current vehicle is calculated, the instantaneous speed may be compared with the limited speed of the current road, to judge whether the instantaneous speed of the current vehicle is greater than the limited speed of the current road, if so, the instantaneous speed of the current vehicle exceeds the limited speed of the current road, and the current vehicle is in an speeding state. At the moment, the speeding information may be output.

In the embodiment of the present disclosure, the time used for the wheels to run one cycle is acquired, then the instantaneous speed of the current vehicle is calculated, whether the instantaneous speed is greater than the limited speed of the current road is judged, and if so, the speeding information is output, so that the shortcoming that the vehicle speed monitoring in the prior art cannot accurately reflect the running speed of the vehicle is overcome, automatic monitoring of the instantaneous speed of the current vehicle is realized, and the accuracy of monitoring data is improved.

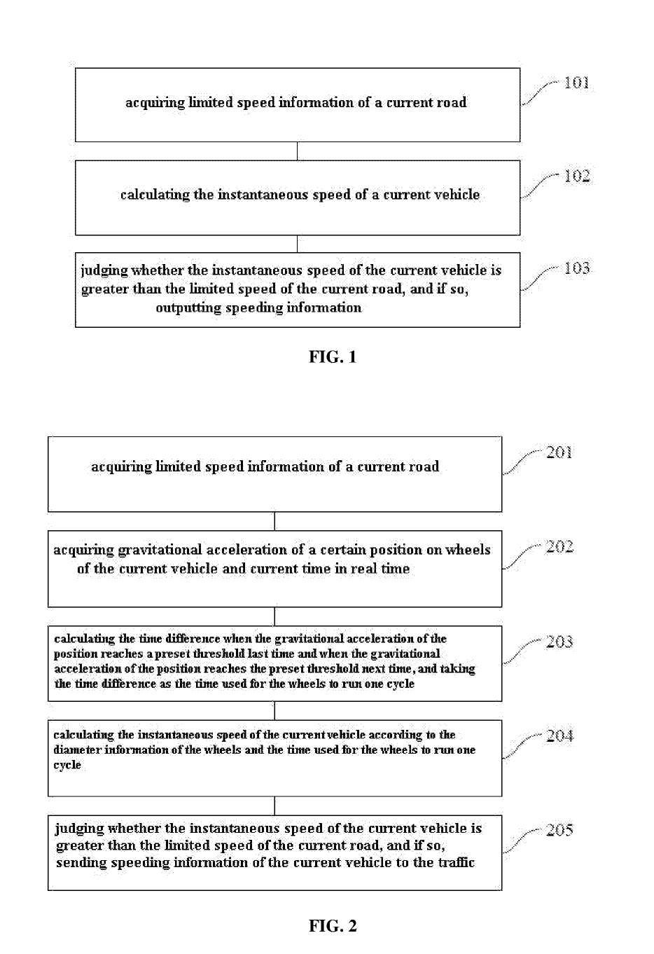

Refer to FIG. 2, which shows a flow diagram of embodiment 2 of the vehicle speed monitoring method of the present disclosure. The method specifically may include the following steps.

Step 201, limited speed information of a current road is acquired.

Different roads have different speed limiting requirements. In the embodiment of the present disclosure, the limited speed information of the current road can be acquired in advance.

Step 202, gravitational acceleration of a certain position on wheels of a current vehicle and current time are acquired in real time.

When the vehicle runs, as the wheels continuously run, the gravitational acceleration of each position on the wheels is continuously changed. Thus, in the embodiment of the present disclosure, the gravitational acceleration of a certain position on the wheels of the current vehicle can be acquired in real time in order to calculate the instantaneous speed of the current vehicle.

Step 203, the time difference when the gravitational acceleration of the position reaches a preset threshold last time and when the gravitational acceleration of the position reaches the preset threshold next time is calculated, and the time difference is used as the time used for the wheels to run one cycle.

When the vehicle runs, the gravitational acceleration of a certain position on the wheels is continuously changed, and as the wheels run, the distance between the position and the ground is within a certain range, so the gravitational acceleration of the position is also changed within a certain value range, and thus, a preset threshold may be set, and the time when the gravitational acceleration of the position reaches the preset threshold twice successively is calculated.

In a preferred embodiment of the present disclosure, the preset threshold may be a gravitational acceleration when a certain position on the wheels contacts the ground, or a gravitational acceleration when the distance between a certain position on the wheels and the ground is longest. When the position contacts the ground, the gravitational acceleration thereof is maximum; and when the distance between the position and the ground is longest, the gravitational acceleration thereof is minimum. Taking the preset threshold which is the gravitational acceleration when a certain position on the wheels contacts the ground as an example, when the acquired gravitational acceleration of the position reaches the preset threshold, the position contacts the ground. Later, as the wheels run, the gravitational acceleration of the position is also continuously changed within a certain value range; and when the gravitational acceleration of the position reaches the preset threshold again, the position just runs one cycle and contacts the ground again.

Thus, the time difference when the gravitational acceleration of the position reaches the preset threshold last time and when the gravitational acceleration of the position reaches the preset threshold next time may be calculated, and the time difference is used as the time used for the wheels to run one cycle.

Step 204, the instantaneous speed of the current vehicle is calculated according to the diameter information of the wheels and the time used for the wheels to run one cycle.

In the embodiment of the present disclosure, calculating the instantaneous speed of the current vehicle according to the diameter information of the wheels and the time used for the wheels to run one cycle specifically may include the following sub-steps:

sub-step S41, calculating the perimeter of the wheels by adopting the diameter information of the wheels; and

sub-step S42, dividing the perimeter by the time used for the wheels to run one cycle to obtain the instantaneous speed of the vehicle.

After the diameter information of the wheels is acquired, the perimeter of the wheels may be calculated by adopting the diameter information, the perimeter is distance when the wheels run one cycle, and then the perimeter is divided by the time used for the wheels to run one cycle to obtain the instantaneous speed of the vehicle.

Step 205, whether the instantaneous speed of the current vehicle is greater than the limited speed of the current road is judged, and if so, speeding information of the current vehicle is sent to the traffic management department.

When the instantaneous speed of the current vehicle is greater than the limited speed of the current road, the current vehicle is in an speeding running state. In the embodiment of the present disclosure, the speeding information may be sent to the traffic management department.

As a preferred embodiment of the present disclosure, when the current vehicle is in the speeding running state, the speeding information may also be output in a vehicle terminal of the current vehicle, to prompt the driver of slowing down and paying attention to safety. In specific implementation, the speeding information may be output on a display interface of the vehicle terminal in the form of characters, or remind the driver in a voice broadcast manner.

As another preferred embodiment of the present disclosure, when the current vehicle is in the speeding running state, the speeding information may also be output to surrounding vehicles, to remind the drivers of the surrounding vehicles of avoiding. In specific implementation, the speeding information may be transmitted to the vehicle terminals of the surrounding vehicles in an Internet of Vehicles V2X communication mode, and the vehicle terminals may display the speeding information on the display interfaces in the form of characters for outputting, or remind the drivers in a voice broadcast manner for avoiding the speeding vehicle.

In the embodiment of the present disclosure, the time used for the wheels to run one cycle is acquired by acquiring the gravitational acceleration of a certain position on the wheels and the current time in real time, then the instantaneous speed of the current vehicle is calculated, and when the instantaneous speed is greater than the limited speed of the current road, the speeding information is sent to the traffic management department, so that automatic monitoring of the instantaneous speed of the current vehicle is realized, and the accuracy of monitoring data is further improved. Meanwhile, in the embodiment of the present disclosure, the driver of the current vehicle may also be reminded to slow down, and the surrounding vehicles may be reminded to avoid, so that road traffic accidents are reduced.

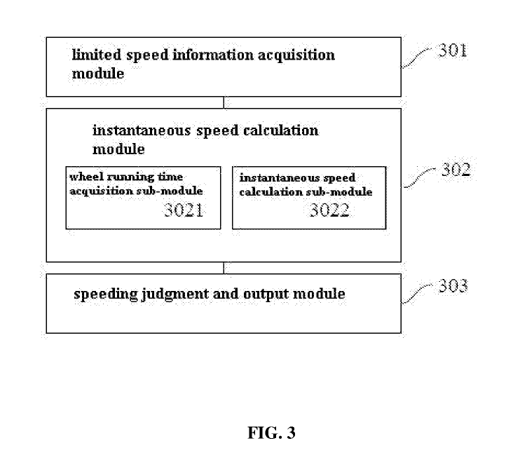

Refer to FIG. 3, which shows a structural schematic diagram of an embodiment of a vehicle speed monitoring device of the present disclosure. The device specifically may include the following modules:

a limited speed information acquisition module 301 for acquiring limited speed information of a current road;

an instantaneous speed calculation module 302 for calculating the instantaneous speed of a current vehicle; and

an speeding judgment and output module 303 for judging whether the instantaneous speed of the current vehicle is greater than the limited speed of the current road, and if so, outputting speeding information;

wherein the current vehicle has diameter information of wheels, and the instantaneous speed calculation module 302 may include the following sub-modules:

a wheel running time acquisition sub-module 3021 for acquiring the time used for the wheels to run one cycle; and

an instantaneous speed calculation sub-module 3022 for calculating the instantaneous speed of the current vehicle according to the diameter information of the wheels and the time used for the wheels to run one cycle.

In the embodiment of the present disclosure, the wheel running time acquisition sub-module 3021 may further include the following units:

a gravitational acceleration and current time acquisition unit 211 for acquiring gravitational acceleration of a certain position on the wheels of the current vehicle and current time in real time; and

a time calculation unit 212 for calculating the time difference when the gravitational acceleration of the position reaches a preset threshold last time and when the gravitational acceleration of the position reaches the preset threshold next time, and taking the time difference as the time used for the wheels to run one cycle.

In the embodiment of the present disclosure, the preset threshold is a gravitational acceleration when a certain position on the wheels contacts the ground, or a gravitational acceleration when the distance between a certain position on the wheels and the ground is longest.

In the embodiment of the present disclosure, the instantaneous speed calculation sub-module 3022 may further include the following units:

a wheel perimeter calculation unit 221 for calculating the perimeter of the wheels by adopting the diameter information of the wheels; and

an instantaneous speed calculation unit 222 for dividing the perimeter by the time used for the wheels to run one cycle to obtain the instantaneous speed of the vehicle.

In the embodiment of the present disclosure, the speeding judgment and output module 303 may further include the following sub-module:

an speeding information output sub-module 3031 for sending the speeding information of the current vehicle to the traffic management department, and/or outputting speeding prompt information in a vehicle terminal of the current vehicle, and/or outputting speeding prompt information to surrounding vehicles.

The present disclosure further provides a vehicle speed monitoring device, comprising: a processor; and a memory for storing instructions executable by the processor; wherein the processor is configured to: acquire limited speed information of a current road; calculate the instantaneous speed of a current vehicle; and judge whether the instantaneous speed of the current vehicle is greater than the limited speed of the current road, and if so, output speeding information; wherein the current vehicle has diameter information of wheels.

The processor is further configured to: acquire the time used for the wheels to run one cycle; and calculate the instantaneous speed of the current vehicle according to the diameter information of the wheels and the time used for the wheels to run one cycle.

The processor is further configured to: acquire gravitational acceleration of a certain position on the wheels of the current vehicle and current time in real time; and calculate the time difference when the gravitational acceleration of the position reaches a preset threshold last time and when the gravitational acceleration of the position reaches the preset threshold next time, and taking the time difference as the time used for the wheels to run one cycle, wherein the preset threshold is a gravitational acceleration when a certain position on the wheels contacts the ground, or a gravitational acceleration when the distance between a certain position on the wheels and the ground is longest.

The processor is further configured to: calculate the perimeter of the wheels by adopting the diameter information of the wheels; and divide the perimeter by the time used for the wheels to run one cycle to obtain the instantaneous speed of the vehicle.

The processor is further configured to: send the speeding information of the current vehicle to the traffic management department, and/or output speeding prompt information in a vehicle terminal of the current vehicle, and/or output speeding prompt information to surrounding vehicles.

The device embodiments described above are only exemplary, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting part of or all of the modules according to actual needs. Those of ordinary skill in the art could understand and implement the embodiments without any creative effort.

Through the descriptions of the above embodiments, those skilled in the art could clearly learn that each embodiment may be implemented by means of software and a necessary general hardware platform, and of course, may be implemented by hardware. Based on such an understanding, the above technical solutions substantially or the part making contribution to the prior art may be embodied in the form of a software product, and the computer software product is stored in a computer readable storage medium, such as a ROM (Read-Only Memory)/RAM (Random Access Memory), a disk, an optical disk, which includes a plurality of instructions enabling computer equipment (which may be a personal computer, a server, or network equipment and the like) to execute the method described in each embodiment or at some part of each embodiment.

Finally, it should be noted that the above embodiments are merely used for illustrating rather than limiting the technical solutions of the present disclosure; although the present disclosure is illustrated in detail with reference to the aforementioned embodiments, it should be understood by those of ordinary skill in the art that modifications may still be made on the technical solutions disclosed in the aforementioned embodiments, or equivalent substitutions may be made to part of technical features thereof, without making, by these modifications or substitutions, the nature of the corresponding technical solutions depart from the spirit and scope of the technical solutions of the embodiments of the present disclosure.

1. A vehicle speed monitoring method, comprising:
acquiring limited speed information of a current road;
calculating the instantaneous speed of a current vehicle; and
judging whether the instantaneous speed of the current vehicle is greater than the limited speed of the current road, and if so, outputting speeding information;
wherein the current vehicle has diameter information of wheels, and the step of calculating the instantaneous speed of the current vehicle comprises:
acquiring the time used for the wheels to run one cycle; and
calculating the instantaneous speed of the current vehicle according to the diameter information of the wheels and the time used for the wheels to run one cycle.

2. The method of claim 1, wherein the step of acquiring the time used for the wheels to run one cycle comprises:
acquiring gravitational acceleration of a certain position on the wheels of the current vehicle and current time in real time; and
calculating the time difference when the gravitational acceleration of the position reaches a preset threshold last time and when the gravitational acceleration of the position reaches the preset threshold next time, and taking the time difference as the time used for the wheels to run one cycle.

3. The method of claim 2, wherein the preset threshold is a gravitational acceleration when a certain position on the wheels contacts the ground, or a gravitational acceleration when the distance between a certain position on the wheels and the ground is longest.

4. The method of claim 1, wherein the step of calculating the instantaneous speed of the current vehicle according to the diameter information of the wheels and the time used for the wheels to run one cycle comprises:
calculating the perimeter of the wheels by adopting the diameter information of the wheels; and
dividing the perimeter by the time used for the wheels to run one cycle to obtain the instantaneous speed of the vehicle.

5. The method of claim 1, wherein the step of outputting speeding information comprises:
sending the speeding information of the current vehicle to the traffic management department, and/or outputting speeding prompt information in a vehicle terminal of the current vehicle, and/or outputting speeding prompt information to surrounding vehicles.

6. A vehicle speed monitoring device, comprising:
a processor; and
a memory for storing instructions executable by the processor;
wherein the processor is configured to:
acquire limited speed information of a current road;
calculate the instantaneous speed of a current vehicle; and
judge whether the instantaneous speed of the current vehicle is greater than the limited speed of the current road, and if so, output speeding information;
wherein the current vehicle has diameter information of wheels, the processor is further configured to:
acquire the time used for the wheels to run one cycle; and
calculate the instantaneous speed of the current vehicle according to the diameter information of the wheels and the time used for the wheels to run one cycle.

7. The device of claim 6, wherein the processor is further configured to:
acquire gravitational acceleration of a certain position on the wheels of the current vehicle and current time in real time; and
calculate the time difference when the gravitational acceleration of the position reaches a preset threshold last time and when the gravitational acceleration of the position reaches the preset threshold next time, and taking the time difference as the time used for the wheels to run one cycle.

8. The device of claim 7, wherein the preset threshold is a gravitational acceleration when a certain position on the wheels contacts the ground, or a gravitational acceleration when the distance between a certain position on the wheels and the ground is longest.

9. The device of claim 6, the processor is further configured to:
calculate the perimeter of the wheels by adopting the diameter information of the wheels; and
divide the perimeter by the time used for the wheels to run one cycle to obtain the instantaneous speed of the vehicle.

10. The device of claim 6, the processor is further configured to:
send the speeding information of the current vehicle to the traffic management department, and/or output speeding prompt information in a vehicle terminal of the current vehicle, and/or output speeding prompt information to surrounding vehicles.

11. The method of claim 2, wherein the step of calculating the instantaneous speed of the current vehicle according to the diameter information of the wheels and the time used for the wheels to run one cycle comprises:
calculating the perimeter of the wheels by adopting the diameter information of the wheels; and
dividing the perimeter by the time used for the wheels to run one cycle to obtain the instantaneous speed of the vehicle.

12. The device of claim 7, the processor is further configured to:
calculate the perimeter of the wheels by adopting the diameter information of the wheels; and
divide the perimeter by the time used for the wheels to run one cycle to obtain the instantaneous speed of the vehicle.
